(19) United States
(12) Patent Application Publication
(10) Pub. No.: US 2024/0198557 A1
(43) Pub. Date: Jun. 20, 2024

(54) METHOD FOR PRODUCING A CONTAINER COMPRISING FIBERS WITH A RIM COMPRISING FIBERS, A CONTAINER COMPRISING FIBERS, AND A DEVICE FOR CARRYING OUT THE METHOD

(71) Applicant: Krones AG, Neutraubling (DE)

(72) Inventors: Andreas Hippel, Wörth an der Donau (DE); Ulrich Lappe, Neutraubling (DE); Jörg Zacharias, Koefering (DE)

(21) Appl. No.: 18/540,501

(22) Filed: Dec. 14, 2023

(30) Foreign Application Priority Data
Dec. 20, 2022 (DE) 102022134098.8

(51) Int. Cl. B27N 5/02; B65D 1/02

(52) U.S. Cl. CPC B27N 5/02; B65D 1/0207; B65D 1/023

(57) ABSTRACT

The disclosure relates to a method for producing a container comprising fibers with a rim comprising fibers, wherein the method comprises: molding a container comprising fibers using fiber-containing pulp, wherein the container comprises a mouth region with a mouth opening, and providing a rim on an outer side of the mouth region using fiber-containing pulp. The disclosure further relates to a container comprising fibers and to a device for carrying out the method.

### CROSS REFERENCE TO RELATED APPLICATION

The present application claims priority to German Patent Application No. 10 2022 134 098.8 filed on Dec. 20, 2022. The entire contents of the above-listed application are hereby incorporated by reference for all purposes.

### TECHNICAL FIELD

The disclosure relates to a method for producing a container comprising fibers with a rim comprising fibers, a container comprising fibers, and a device for carrying out the method.

### BACKGROUND

It is known to equip containers comprising fibers with a plastic thread and plastic lids in order to be able to ensure reclosability of such a container. Reclosability of containers can be desirable in particular in the case of filling quantities of more than 200 ml since this quantity is generally not emptied in one go.

### SUMMARY

### Object

The object of the disclosure is to provide a method for producing a container comprising fibers with a rim comprising fibers, a container comprising fibers, and a device for carrying out the method, which facilitates a handling process of containers comprising fibers and can also enable a reclosability of such a container.

### Achievement

The object is achieved by the method for producing a container comprising fibers with a rim comprising fibers, the container comprising fibers, and the device for carrying out the method as described herein.

The method according to the disclosure for producing a container comprising fibers with a rim comprising fibers comprises molding a container comprising fibers using fiber-containing pulp, wherein the container comprises a mouth region with a mouth opening, and providing a rim on an outer side of the mouth region using fiber-containing pulp.

The fibers may comprise lignin, banana leaves and/or wild quinine. The fibers may, for example, comprise cellulose fibers, fibers of conifers, of leafy woody plants and/or plane trees and/or grasses, reeds and/or bamboo or the like. The fibers may comprise silk threads, spider silk, algae, natural fibers (such as Danube silphie fibers, hemp, maize, cotton), banana peel, orange peel, grass, straw, potato starch or processed cow dung. It is also possible to provide cellulose fibers which originate from a process by which they were artificially grown. In the event of material bottlenecks of wood as the basic material for a fluid mass with fibers, these alternative materials can completely or partially replace the basic material.

The fibers can comprise fiber mixtures made of non-wood material, for example cotton, hemp and/or textile fibers.

For example, the fibers may comprise viscose fibers. A viscose fiber is an artificial fiber made of regenerated cellulose, wherein the viscose fibers have, as starting base, 100% cellulose treated in a multi-stage process. The viscose fibers may comprise a flat or cable-shaped structure, a trilobal shape or a double trilobal structure. The fibers may comprise a flat or hollow structure or a corrugated or rough outer surface.

Various types of fibers may also be used in combination. For example, fibers with different outer surfaces and/or shapes and/or hollow structure and/or flat structure and/or of different materials may be combined. The fibers can be original, smooth, chopped, milled or fibrillated.

Due to the natural origin of the fibers, they may be biodegradable. In addition, they are sustainable and renewable.

The fibers may be used in a pulp. The pulp may be or comprise a mixture of water, for example with additives, and fibers.

The container may be a bottle or a can.

The molding of the container comprising fibers using the fiber-containing pulp can take place in a mold which can represent a negative form of an outer contour of the container to be produced, or by means of an injection molding method.

The fiber-containing pulp that is used for molding the container comprising fibers and the fiber-containing pulp that is used to provide the rim on an outer side of the mouth region can be the same or different. If, for example, the rim is subsequently provided on the container, the pulp used for this purpose can be different from the pulp with which the container was molded.

Providing the rim on an outer side of the mouth region using fiber-containing pulp can comprise providing a single rim or providing more than one rim, for example two, three, four or more rims. The multiple rims can be spaced apart from one another. The same distance or different distances can be provided between the rims.

The rim can be or comprise a structure which at least partially projects from an outer surface of the container.

The rim can be provided at least partially circumferentially. For example, the rim can be provided protruding, for example protruding radially. The rim can be or comprise a structure similar to a support ring or like a support ring.

The rim can be provided in such a way that its cross section can be rectangular, triangular, polygonal or trapezoidal, for example in each case with one or more rounded corners, at least partially semi-oval or semi-elliptical. The one or more rounded corners or the arc of the semi-oval or semi-elliptical cross section can be provided facing away from an outer container wall. For the rim, the one or more rounded corners of the cross section can accordingly mean one or more rounded edges.

An upper edge of the rim can be provided flush with the mouth opening or the upper edge of the rim can be provided at a distance from the mouth opening. The upper edge of the rim can be regarded as the transition between the rim and the container, for example its outer container wall. The mouth opening can be described by a plane that would close the mouth opening. The distance from the mouth opening can be measured, for example, parallel to a container longitudinal axis.

As a further embodiments, provision can be made for multiple (at least two) rims to be provided on a neck region of the container, which rims can, for example, be arranged spaced apart from one another, wherein the same or different distances can, for example, be provided. For example, as described above, a rim and a further rim at a defined distance therefrom with an identical or different cross section (as described above) can be provided on the upper edge at the mouth opening. The upper rim can comprise a function for reclosing; the lower rim can comprise a function for handling (e.g., neck handling) of the container.

The rim can be provided during the molding of the container. For example, the fiber-containing pulp for the container and the rim can be the same. For example, the rim can be provided after the container has been molded, wherein, for example, the fiber-containing pulp for the container and the rim can be the same or different.

The method can furthermore comprise providing a lid for closing the mouth opening, wherein, for example, the lid can comprise dry fiber-containing pulp, cardboard and/or carton.

Closing can comprise arranging the lid as a single-time closure. When a container closed by this lid has been opened, it is not provided that this lid can again be formed for reclosing the container, i.e., its mouth opening.

The lid can comprise a U-shaped form opposite to the rim, for closing the mouth region. When a container closed by this lid has been opened, it is provided that, due to its shape, this lid can again be used for reclosing the container, i.e., its mouth opening.

Closing can comprise arranging the lid as a recurring closure. If a container closed by this lid has been opened, it is provided that this lid can again be used for reclosing the container, i.e., its mouth opening.

Furthermore, a container comprising fibers is provided, which was produced using the method as described above or below.

The rim of the container can be at least partially circumferential, wherein, for example, the rim can be formed protruding, for example protruding radially.

A cross section of the rim can be rectangular, triangular, polygonal or trapezoidal, for example in each case with one or more rounded corners, at least partially semi-oval or semi-elliptical.

An upper edge of the rim can terminate flush with the mouth opening, or the upper edge of the rim can have a distance from the mouth opening.

The container can furthermore comprise a lid for closing the mouth opening, wherein, for example, the lid can comprise dry fiber-containing pulp, cardboard and/or carton.

The lid can comprise a U-shaped form opposite to the rim.

Furthermore, a device is provided for carrying out the method, as described above or further below.

The device can comprise a device for molding the container comprising fibers using fiber-containing pulp, wherein the container can comprise a mouth region with a mouth opening. Furthermore, the device can comprise a device for providing a rim on an outer side of the mouth region using fiber-containing pulp.

### BRIEF DESCRIPTION OF FIGURES

The accompanying Figures show, by way of example, aspects and/or exemplary embodiments of the disclosure for better understanding and illustration. In the figures:

FIG. 1 shows a first embodiment of a container comprising fibers with a rim comprising fibers,

FIG. 2 shows a second embodiment of a container comprising fibers with a rim comprising fibers,

FIG. 3A shows a first embodiment of a rim provided on a container,

FIG. 3B shows a second embodiment of a rim provided on a container,

FIG. 3C shows a third embodiment of a rim provided on a container,

FIG. 3D shows a fourth embodiment of a rim provided on a container,

FIG. 3E shows a fifth embodiment of a rim provided on a container,

FIG. 4A shows a sixth embodiment of a rim provided on a container,

FIG. 4B shows a seventh embodiment of a rim provided on a container,

FIG. 4C shows an eighth embodiment of a rim provided on a container,

FIG. 4D shows a ninth embodiment of a rim provided on a container,

FIG. 4E shows a tenth embodiment of a rim provided on a container,

FIG. 5A shows a mouth region of a container with a rim, onto which a lid is arranged as a recurring closure,

FIG. 5B shows various views of the lid removed from the rim,

FIG. 5C shows the container reclosed with the lid, and

FIG. 6 shows a carousel with holding devices for holding containers below the rim.

### DETAILED DESCRIPTION OF FIGURES

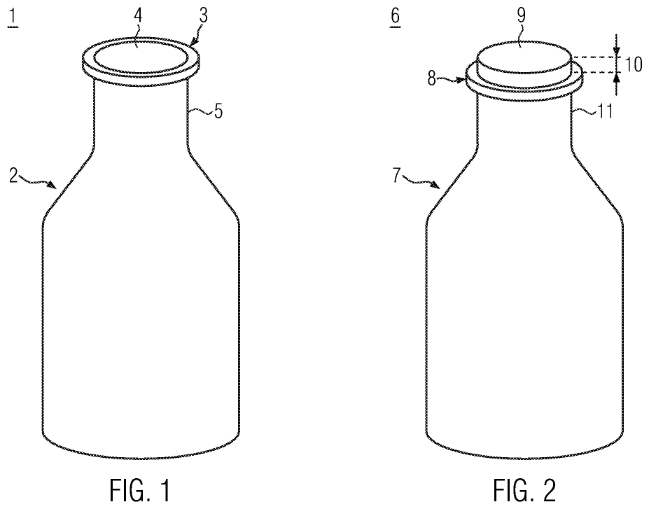

FIG. 1 shows a first embodiment 1 of a container 2 comprising fibers with a rim 3 comprising fibers. The rim 3 is provided circumferentially on an outer side of a mouth region 5. The rim 3 is provided protruding radially. An upper edge of the rim 3 in this case terminates with a mouth opening 4 of the container 2. The rim 3 can be provided for the purpose of arranging a lid thereon. The lid can be provided as a single-time closure or as a recurring closure. In addition, the rim 3 can also serve as a type of support ring, for example as a counterpart to a holding device for holding the container below the rim 3.

FIG. 2 shows a second embodiment 6 of a container 7 comprising fibers with a rim 8 comprising fibers. The rim 8 is provided circumferentially on an outer side of a mouth region 11 of the container 7 and protruding radially. An upper edge of the rim 8 has a distance 10 from the mouth opening 9 of the container 7. The rim 8 can be provided for arranging a lid thereon. The lid can be provided as a single-time closure or as a recurring closure. In addition, the rim 8 can also serve as a type of support ring, for example as a counterpart to a holding device for holding the container below the rim 8.

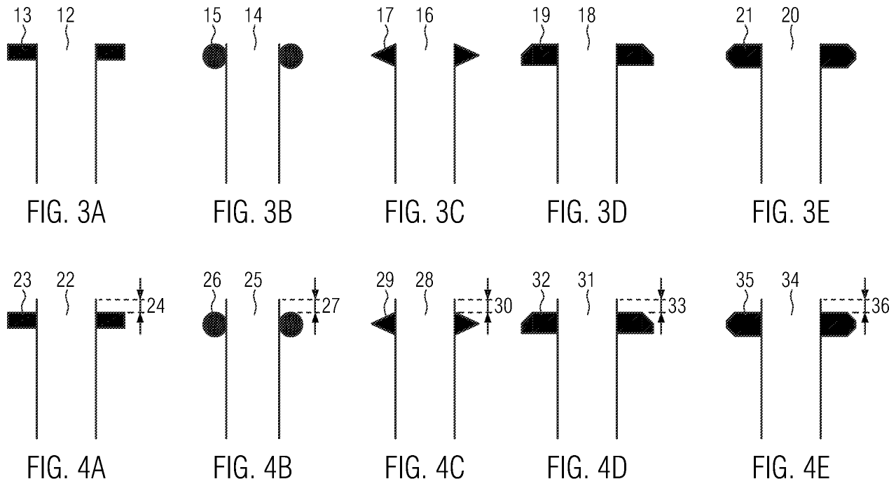

FIG. 3A shows a first embodiment of a rim 13, which is provided on a container and which is provided at least partially circumferentially on an outer side of a mouth region. The rim 13 is provided protruding radially and has a rectangular cross section. An upper edge of the rim 13 in this case terminates with a mouth opening 12 of the container.

FIG. 3B shows a second embodiment of a rim 15, which is provided on a container and which is provided at least partially circumferentially on an outer side of a mouth region of the container. The rim 15 is provided protruding radially and has a round cross section. An upper edge of the rim 15 in this case terminates with a mouth opening 14 of the container. An upper edge can be understood here as a circular ring, which can be provided by the uppermost rounded portion of the rim 15.

For example, the round cross section of the rim can extend at least partially into the mouth region so that the cross section of the rim that starts on the outer side of the mouth region can correspond to a circular segment (also referred to as a circular portion) with a height that can be greater than a radius of the circle. The height can correspond to 1.5 times to 1.8 times the radius. The limits of the range may be included. The height cannot be greater than twice the radius. Such a rim can be formed if the rim is provided during the molding of the container.

FIG. 3C shows a third embodiment of a rim 17, which is provided on a container and which is provided at least partially circumferentially on an outer side of a mouth region of the container. The rim 17 is provided protruding radially and has a triangular cross section. An upper edge of the rim 17 in this case terminates with a mouth opening 16 of the container.

FIG. 3D shows a fourth embodiment of a rim 19, which is provided on a container and which is provided at least partially circumferentially on an outer side of a mouth region of the container. The rim 19 is provided protruding radially. The rim 19 has a pentagonal cross section, which corresponds to a rectangle with a cut-off corner facing away from the container. An upper edge of the rim 19 in this case terminates with a mouth opening 18 of the container.

FIG. 3E shows a fifth embodiment of a rim 21, which is provided on a container and which is provided at least partially circumferentially on an outer side of a mouth region of the container. The rim 21 is provided protruding radially and has a hexagonal cross section, which corresponds to a rectangle with two cut-off corners facing away from the container. An upper edge of the rim 21 in this case terminates with a mouth opening 20 of the container.

FIG. 4A shows a sixth embodiment of a rim 23, which is provided on a container and which is provided at least partially circumferentially on an outer side of a mouth region. The rim 23 is provided protruding radially and has a rectangular cross section. In this case, an upper edge of the rim 23 has a distance 24 from a mouth opening 22 of the container.

FIG. 4B shows a seventh embodiment of a rim 26, which is provided on a container and which is provided at least partially circumferentially on an outer side of a mouth region of the container. The rim 26 is provided protruding radially and has a round cross section. In this case, an upper edge of the rim 26 has a distance 27 from a mouth opening 25 of the container. An upper edge can be understood here as a circular ring, which can be provided by the uppermost rounded portion of the rim 26.

FIG. 4C shows an eighth embodiment of a rim 29, which is provided on a container and which is provided at least partially circumferentially on an outer side of a mouth region of the container. The rim 29 is provided protruding radially and has a triangular cross section. In this case, an upper edge of the rim 29 has a distance 30 from a mouth opening 28 of the container.

FIG. 4D shows a ninth embodiment of a rim 32, which is provided on a container and which is provided at least partially circumferentially on an outer side of a mouth region of the container. The rim 32 is provided protruding radially. The rim 32 has a pentagonal cross section, which corresponds to a rectangle with a cut-off corner facing away from the container. In this case, an upper edge of the rim 32 has a distance 33 from a mouth opening 31 of the container.

FIG. 4E shows a tenth embodiment of a rim 35, which is provided on a container and which is provided at least partially circumferentially on an outer side of a mouth region of the container. The rim 35 is provided protruding radially and has a hexagonal cross section, which corresponds to a rectangle with two cut-off corners facing away from the container. In this case, an upper edge of the rim 35 has a distance 36 from a mouth opening 34 of the container.

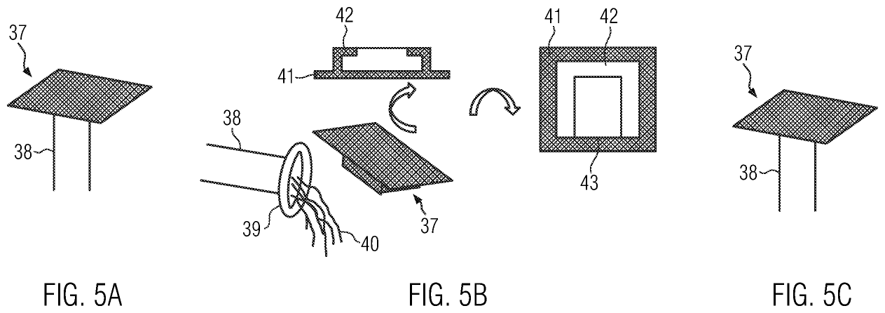

FIG. 5A shows a mouth region 38 of a container with a rim, onto which a lid 37 is arranged as a recurring closure. When the container closed by this lid 37 has been opened, it is provided that the lid 37 can be used again for reclosing the container by the lid 37 being arranged again on the rim.

FIG. 5B shows various views of the lid 37 removed from the rim 39. After removal of the lid 37, the product 40 can, for example, be poured out of the container. The cross section of the lid 37 shows that the lid 37 comprises an upper part 41 and a U-shaped form 42. The U-shaped form 42 projects from an underside of the upper part 41 in such a way that it can at least partially encompass the rim 39.

The plan view of the underside of the lid 37 shows that the U-shaped form 42 additionally comprises a lid opening 43, which is arranged on the open side of the U.

FIG. 5C shows the container reclosed with the lid 37. For reclosing, the lid 37 can be pushed with the lid opening 43 forward onto the rim 39 so that an underside of the upper part 41 can close a mouth opening of the container and the U-shaped form 42 can at least partially encompass the rim 39. Due to the interaction of the upper part 41, the U-shaped form 42, the rim 39 and the mouth opening, the mouth opening and thus the container can be reclosed by means of the lid 37.

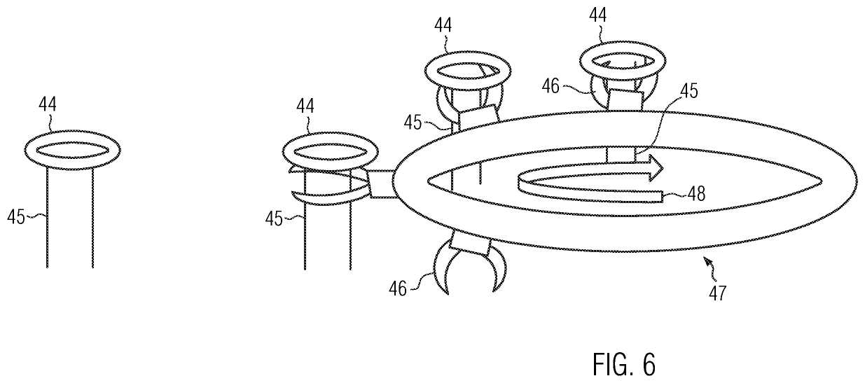

FIG. 6 shows a carousel 47 with holding devices 46 for holding containers underneath the rim 44, which is arranged on a mouth region 45 of the container. In the representation, the upper edge of the rim 44 is provided in each case flush with the mouth opening of the container. The carousel 47 can be rotated in a direction 48 about an axis of rotation so that the holding devices 46 arranged on the carousel 47 can each successively hold one container below the rim 44 since the holding device 46 can interact with the rim 44 in such a way that the holding device 46 can be stopped on a lower edge of the rim 44 or on the rim 44 itself, for example during a movement along the mouth region 45. With the holding devices 46, individual containers can thus be successively received and held below the rim 44 and can be transported along the circumference of the carousel 47 and subjected, for example, to a container treatment.

1. Method for producing a container comprising fibers with a rim comprising fibers, wherein the method comprises:
molding a container comprising fibers using fiber-containing pulp, wherein the container comprises a mouth region with a mouth opening,
comprising
providing a rim on an outer side of the mouth region using fiber-containing pulp.

2. The method according to claim 1, wherein the rim is provided at least partially circumferentially.

3. The method according to claim 1, wherein the rim is provided in such a way that its cross section is rectangular, triangular, polygonal or trapezoidal, in each case with one or more rounded corners, at least partially semi-oval or semi-elliptical.

4. The method according to claim 1, wherein an upper edge of the rim is provided flush with the mouth opening, or wherein the upper edge of the rim is provided at a distance from the mouth opening.

5. The method according to claim 1, wherein the rim is provided during the molding of the container, wherein, the fiber-containing pulp for the container and the rim is the same, or wherein the rim is provided after the molding of the container, wherein, the fiber-containing pulp for the container and the rim is the same or different.

6. The method according to claim 1, further comprising:
providing a lid for closing the mouth opening, wherein, the lid comprises dry fiber-containing pulp, cardboard and/or carton.

7. The method according to claim 6, wherein closing comprises arranging the lid as a single-time closure.

8. The method according to claim 6, wherein the lid comprises a U-shaped form opposite to the rim, for closing the mouth opening.

9. The method according to claim 6, wherein closing comprises arranging the lid as a recurring closure.

10. Container comprising fibers produced using the according to claim 1.

11. The container according to claim 10, wherein the rim is at least partially circumferential, wherein the rim is formed protruding radially.

12. The container according to claim 10, wherein a cross section of the rim is rectangular, triangular, polygonal or trapezoidal, in each case with one or more rounded corners, at least partially semi-oval or semi-elliptical.

13. The container according to claim 10, wherein an upper edge of the rim terminates flush with the mouth opening, or wherein the upper edge of the rim has a distance from the mouth opening.

14. The container according to claim 10, further comprising a lid for closing the mouth opening, wherein, the lid comprises dry fiber-containing pulp, cardboard and/or carton.

15. The container according to claim 14, wherein the lid comprises a U-shaped form opposite to the rim.

16. A device for carrying out the method according to claim 1.

17. The method according to claim 2, wherein, the rim is provided protruding radially.
